(19) United States
(12) Patent Application Publication
(10) Pub. No.: US 2024/0062238 A1
(43) Pub. Date: Feb. 22, 2024

(54) SOFTWARE FOR MONITORING TARGETED FRONT DOOR MEDIA DISTRIBUTION CAMPAIGNS

(71) Applicant: Darryl H. Terrell, Snellville, GA (US)

(72) Inventor: Darryl H. Terrell, Snellville, GA (US)

(21) Appl. No.: 18/235,805

(22) Filed: Aug. 18, 2023

Related U.S. Application Data
(60) Provisional application No. 63/398,849, filed on Aug. 18, 2022.

(51) Int. Cl. G06Q 30/0241; G06Q 10/0639; H04L 67/52

(52) U.S. Cl. CPC G06Q 30/0241; G06Q 10/06398; H04L 67/52

(57) ABSTRACT

Implementations of a software for monitoring targeted front door media distribution campaigns comprising for a portable computing device, such as a smart phone, configured to provide an easy to use user-interface and functionality to provide picture proof that advertisements have been placed on doors in a targeted geographical area, including when and where the advertisements were placed, and to collect data to create live maps, performance metrics, and reports, and in some implementations, a corresponding software application for a computing device, such as a desktop or laptop computer.

### CROSS REFERENCE TO RELATED APPLICATION

This application claims the benefit of U.S. Patent Application Ser. No. 63/398,849, which was filed on Aug. 18, 2022, and is incorporated herein by reference in its entirety.

### TECHNICAL FIELD

This disclosure relates to implementations of a software for monitoring targeted front door media distribution campaigns.

### BACKGROUND

Targeted front door media distribution is a form of advertising where advertisements of a business are placed on the front door of targeted prospective customers (as shown in FIG. 8) in a targeted geographical area. For a campaign, the work of placing these advertisements on the doors can be labor intensive. There does not exist an effective means to prove that these advertisements are actually being placed on the doors of prospective customers and when (i.e., the date and time) the advertisements are placed on the doors. Also, there are no effective means to receive real-time monitoring of the progress of the campaign (i.e., the progress of placing the advertisement on doors for a campaign).

### BRIEF DESCRIPTION OF THE DRAWINGS

FIG. 1A illustrates an implementation of an example environment of the software for monitoring targeted front door media distribution campaigns according to the present disclosure.

FIG. 1B illustrates an example computer system, which may be used with implementations of the present disclosure.

FIGS. 2-5 illustrate implementations of example user interfaces of the software for monitoring targeted front door media distribution campaigns according to the present disclosure.

FIGS. 6A and 6B illustrate a flowchart of an example method of operation of the software for monitoring targeted front door media distribution campaigns when used by a user such as an advertisement deliverer according to the present disclosure.

FIGS. 7A-7E illustrate a flowchart of an example method of operation of the software for monitoring targeted front door media distribution campaigns when used by an administrator such as a supervisor or manager of the advertisement deliverers according to the present disclosure.

FIG. 8 illustrates an example of existing targeted front door media distribution.

### DETAILED DESCRIPTION

Implementations of a software for monitoring targeted front door media distribution campaigns are provided. In some implementations, the software for monitoring targeted front door media distribution campaigns comprises a mobile application for a portable computing device, such as a smart phone or similar device (e.g., an iPhone® or iPad®). In some implementations, the software for monitoring targeted front door media distribution campaigns may comprise a corresponding software application for a computing device, such as a desktop or laptop computer. Therefore, the software for monitoring targeted front door media distribution campaigns may be described or otherwise referred to collectively herein the present disclosure as an “application” or “software” for a “computing device”.

In some implementations, the software for monitoring targeted front door media distribution campaigns is configured to provide an easy to use user-interface and functionality to provide picture proof that advertisements have been placed on doors in a targeted geographical area, including when and where the advertisements were placed.

In some implementations, the software for monitoring targeted front door media distribution campaigns is configured to collect the data from the application to create live maps, performance metrics, and reports.

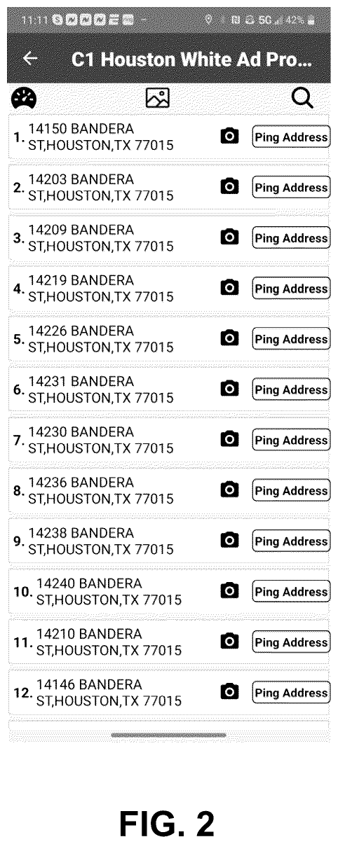

In some implementations, the software for monitoring targeted front door media distribution campaigns is configured to receive a plurality of addresses for delivery of an advertisement. For example, as shown in FIG. 2, in some implementations, the software for monitoring targeted front door media distribution campaigns is configured to display the addresses on a computing device for a deliverer.

In some implementations, each address is displayed on a separate row. In some implementations, the addresses are sorted by a particular delivery sequence (e.g., a walk sequence or drive sequence).

In some implementations, next to each address there is a camera icon (or other indicia) for the deliverer to select to take a picture of the advertisement on the door after the deliverer has placed the advertisement on the door.

In some implementations, another user selectable indicia (e.g., the “ping address” button shown in FIG. 2) may be selected to capture the coordinates of the deliverer. In some implementations, the deliverer will capture his coordinates while standing at the location of placement of the advertisement.

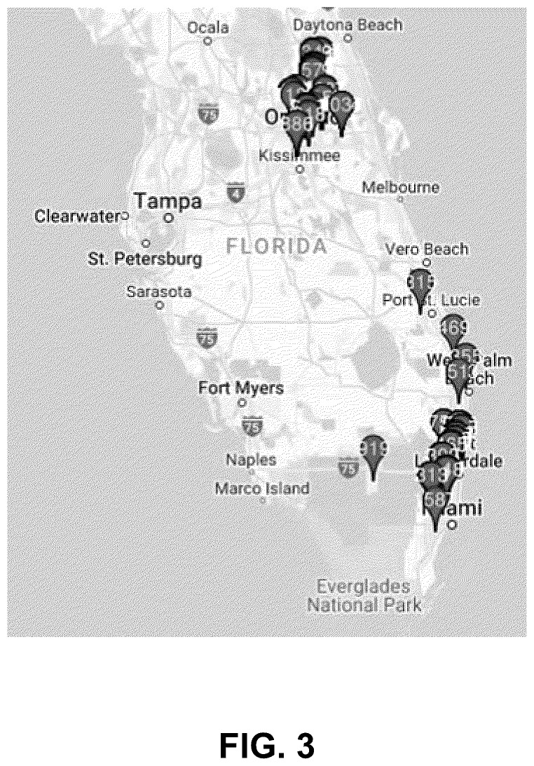

In some implementations, for each picture taken, the picture, the date and time the picture was taken, and the coordinates captured are transmitted over a network, typically in real time, and stored on a server to be used to create a live map (such as shown in FIG. 3) on another display device.

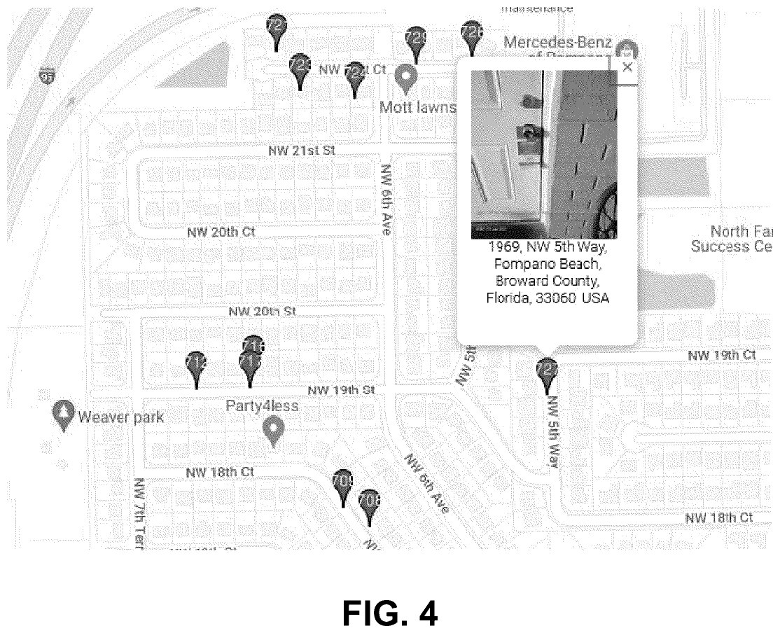

In some implementations, the live map shows the progress of a campaign and the delivery of the advertisements. For example, as shown in FIG. 4, in some implementations, the live map shows a clickable indicia on the map for each delivery.

In some implementations, when the clickable indicia is clicked (or selected), the picture taken by the deliverer is displayed as proof of the placement of the advertisement on the front door at the address indicated. In this way, in some implementations, a business can confirm that the deliverer has placed the advertisement on the doors for a campaign.

Returning to FIG. 2, in some implementations, the software for monitoring targeted front door media distribution campaigns is configured to allow the deliverer to filter the list of addresses provided for a campaign based on a particular address or street.

In some implementations, the software for monitoring targeted front door media distribution campaigns is configured to allow the deliverer to indicate that an address is undeliverable, the reasons why the address is undeliverable, and picture proof of the condition of the address. For example, in some implementations, an address may be undeliverable because it is behind a gate, under construction, or inaccessible (e.g., in a high-rise building with no access).

As shown in the example user-interfaces illustrated in FIGS. 2-4, in some implementations, the software for monitoring targeted front door media distribution campaigns is configured to display indicia of good addresses (e.g., using a green color) and indicia of bad addresses (e.g., using a red color).

In some implementations, a list of addresses may not be provided, and in some campaigns, the deliverer may be tasked with delivering as many advertisements as possible in a particular area. In some implementations, in such situations, the deliverer can take pictures and capture coordinates of each delivery using the software for monitoring targeted front door media distribution campaigns.

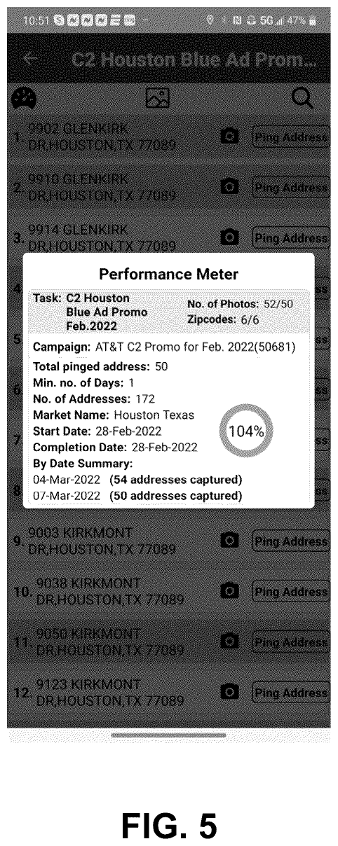

In some implementations, with the data collected (e.g., pictures, date and time stamps, and coordinates), the performance of the deliverer for a campaign can be measured and various reports can be created using the software for monitoring targeted front door media distribution campaigns. For example, an example of a performance meter created by the software for monitoring targeted front door media distribution campaigns is illustrated in FIG. 5.

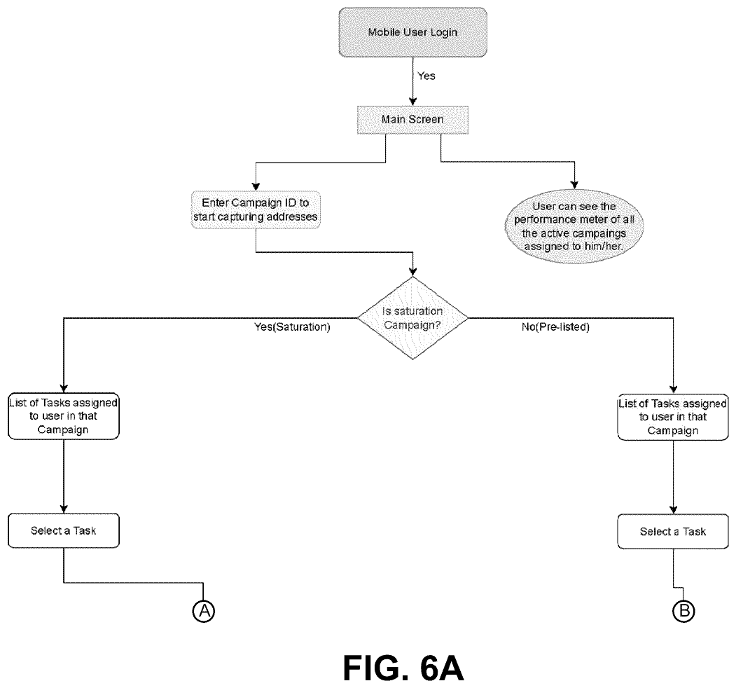

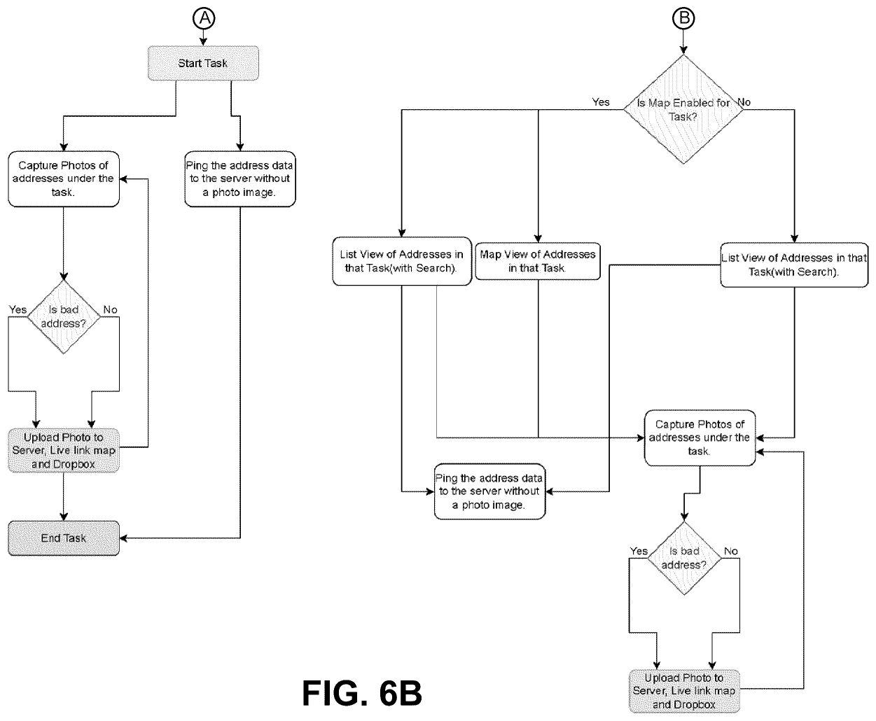

FIGS. 6A and 6B illustrate a flowchart of an example method of operation of the software for monitoring targeted front door media distribution campaigns when used by a user such as an advertisement deliverer.

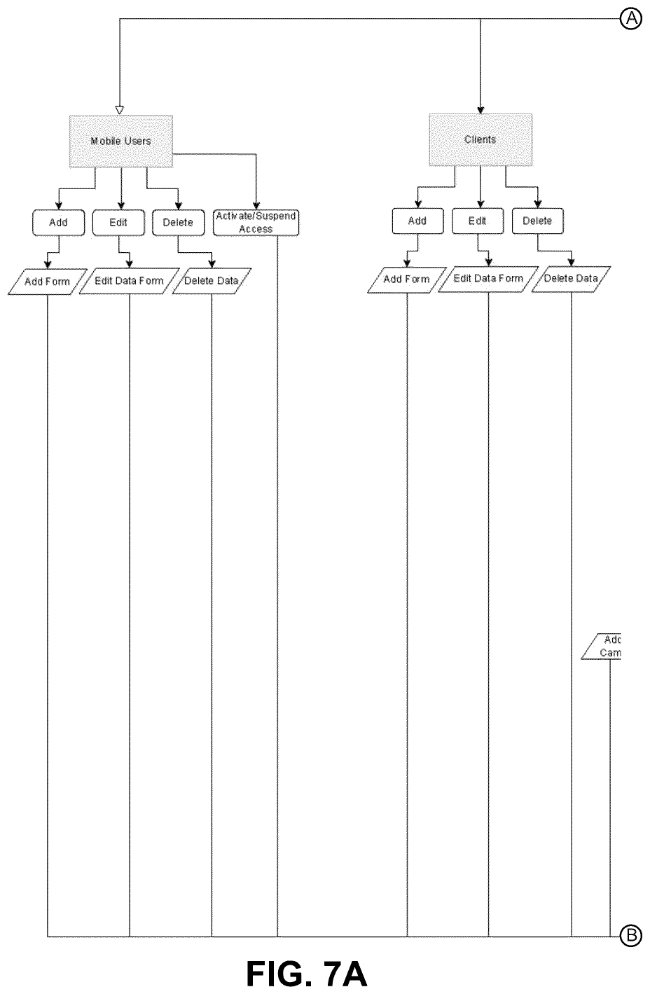

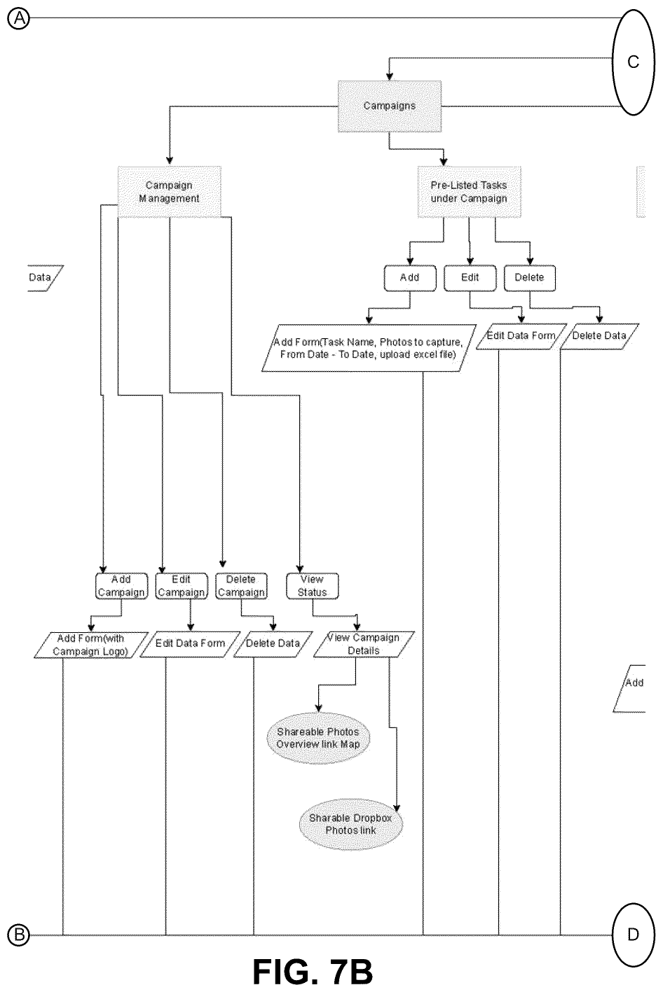

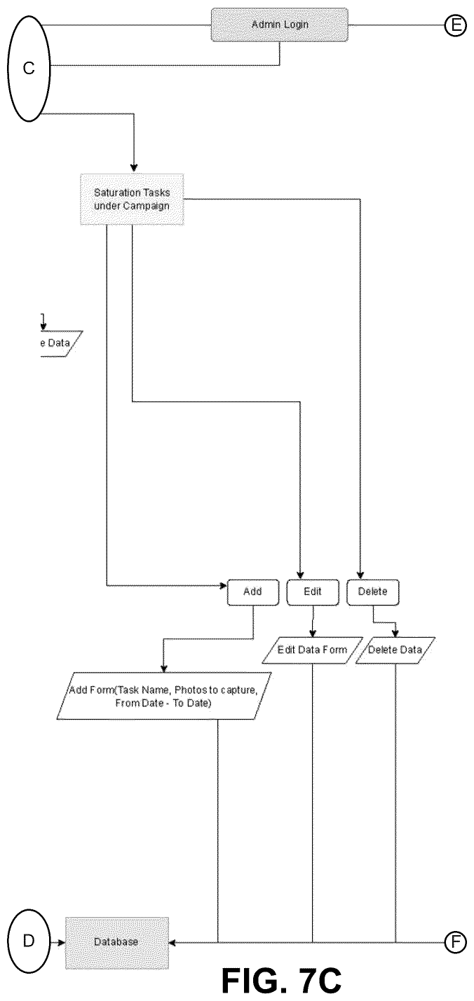

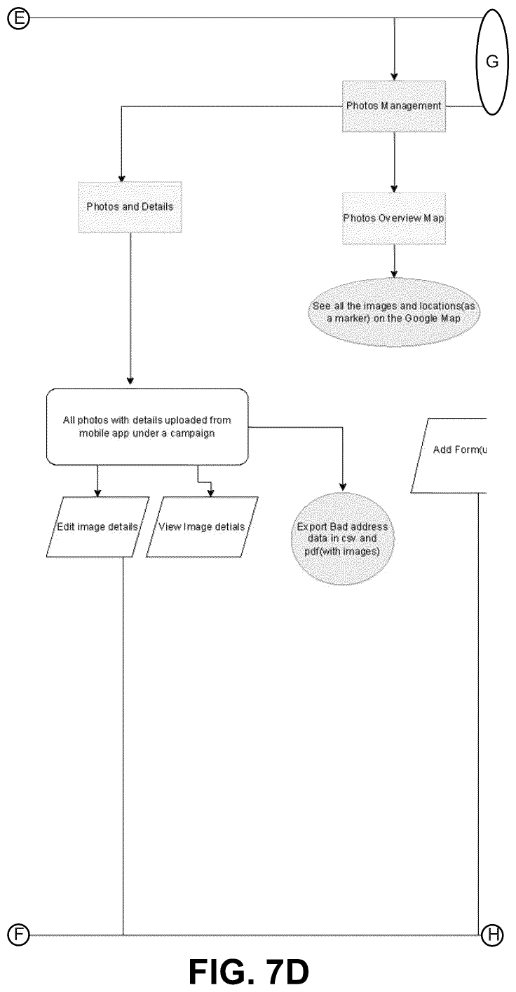

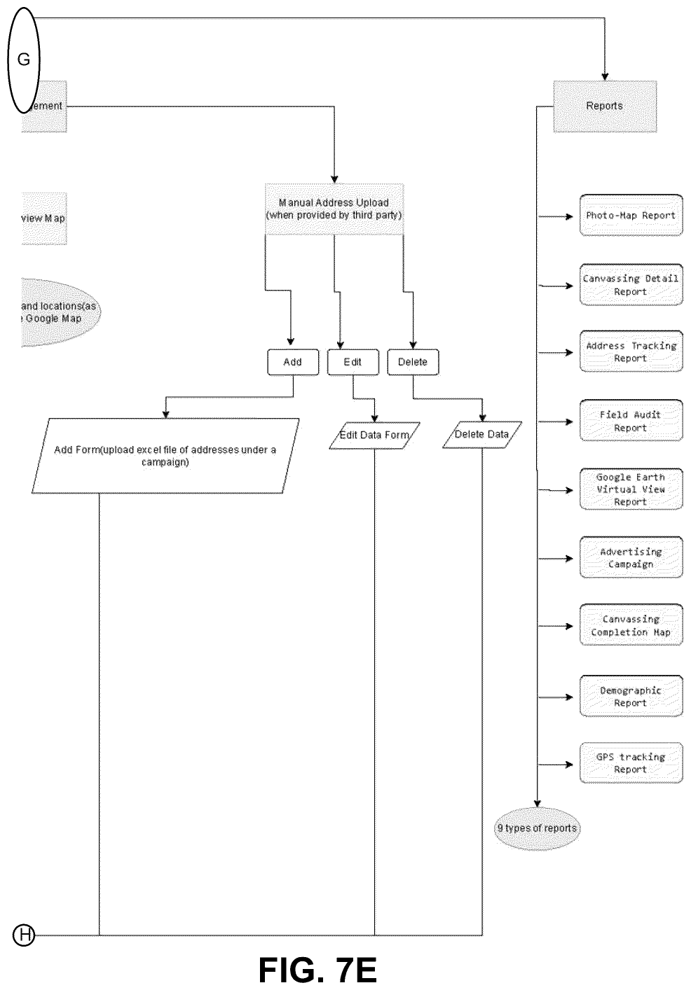

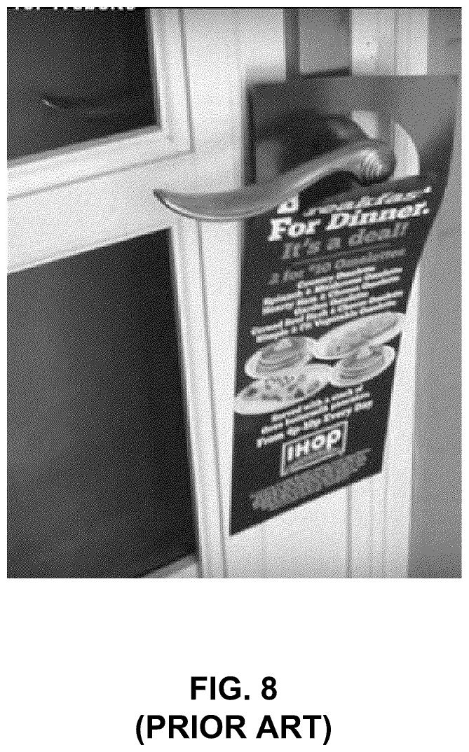

FIGS. 7A-7E illustrate a flowchart of an example method of operation of the software for monitoring targeted front door media distribution campaigns when used by an administrator such as a supervisor or manager of the advertisement deliverers. FIG. 7E includes a listing of various reports that can be provided by the software for monitoring targeted front door media distribution campaigns.

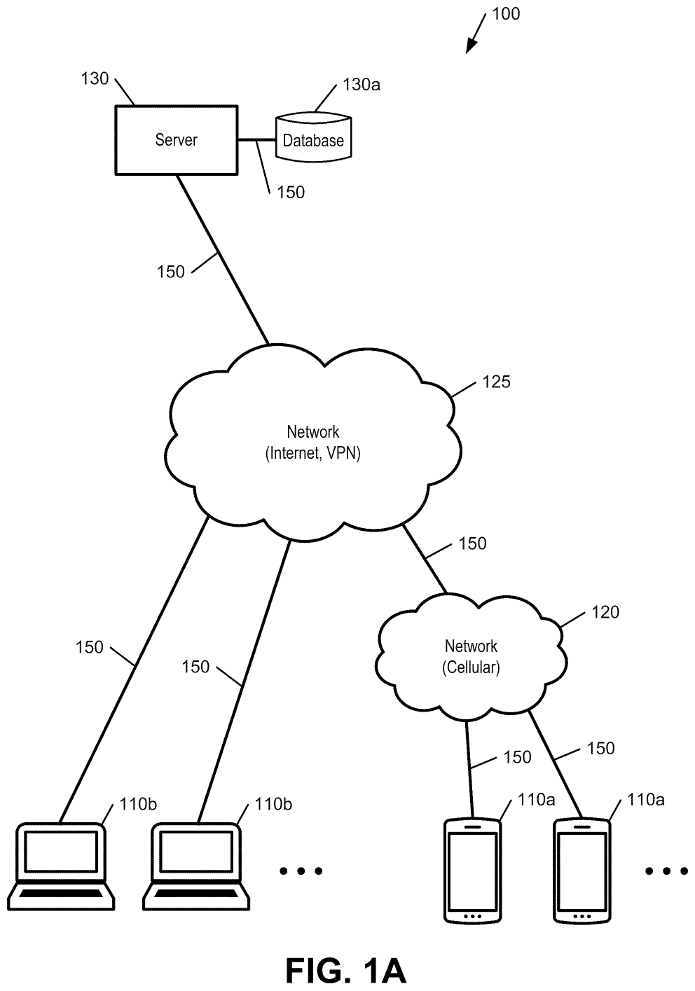

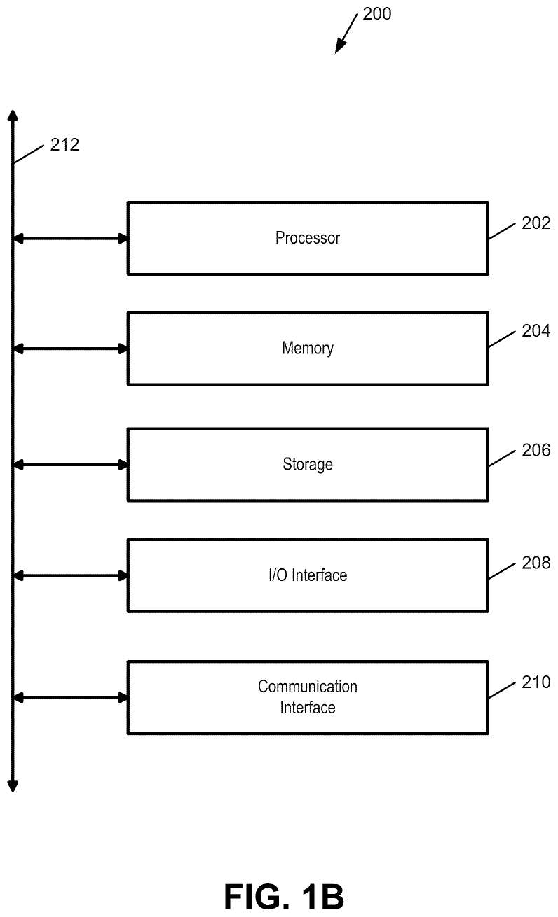

FIG. 1A illustrates an implementation of an example environment 100 of a software for monitoring targeted front door media distribution campaigns according to the present disclosure.

As shown in FIG. 1A, in some implementations, the environment 100 may include one or more client devices 110a and 110b (collectively “client devices 110”), wireless cellular network 120, network 125, and servers 130. In some implementations, the environment 100 may also include one or more data storages 130a linked to the servers 130.

As described above, in some implementations, the client device 110 may be used provide an easy to use user-interface and functionality to provide picture proof that advertisements have been placed on doors in a targeted geographical area, including when and where the advertisements were placed. In some implementations, the client device 110 may be used to collect the data from the application for creating live maps, performance metrics, and reports.

As described above, in some implementations, the client device 110 may be used to receive a plurality of addresses for delivery of an advertisement. In some implementations, the client device 110 may be used to display the addresses for a deliverer.

As described above, in some implementations, the client device 110 may be used to display each address on a separate row. In some implementations, the client device 110 may be used to sort the addresses by a particular delivery sequence (e.g., a walk sequence or drive sequence).

As described above, in some implementations, the client device 110 may be used for the deliverer to select a displayed camera icon (or other indicia) to take a picture of the advertisement on the door after the deliverer has placed the advertisement on the door. In some implementations, the client device 110 may be used to select a displayed indicia (e.g., the “ping address” button shown in FIG. 2) to capture the coordinates of the deliverer, such as while standing at the location of placement of the advertisement.

As described above, in some implementations, the client device 110 may be used to display clickable indicia on a live map for each advertisement delivery. In some implementations, the client device 110 may be used to display the picture taken by the deliverer as proof of the placement of the advertisement on the front door at the address indicated.

As described above, in some implementations, the client device 110 may be used to allow the deliverer to filter the list of addresses provided for a campaign based on a particular address or street. In some implementations, the client device 110 may be used to allow the deliverer to indicate that an address is undeliverable, the reasons why the address is undeliverable, and picture proof of the condition of the address.

As described above, in some implementations, the client device 110 may be used to display indicia of good addresses (e.g., using a green color) and indicia of bad addresses (e.g., using a red color). In some implementations, the client device 110 may be used to allow the deliverer to take pictures and capture coordinates of each delivery using the software for monitoring targeted front door media distribution campaigns, such as when a list of addresses is not provided and/or the deliverer is tasked with delivering as many advertisements as possible in a particular area.

As described above, in some implementations, the client device 110 may be used to display a performance meter indicating the performance of the deliverer for a campaign.

In some implementations, the server 130 may be used to receive collected data from the application transmitted over a network from the client device 110 to create live maps, performance metrics, and reports. In some implementations, the server 130 may be used to transmit over a network the created live maps, performance metrics, and reports to the client device 110.

In some implementations, the server 130 may be used to transmit over a network a plurality of addresses for delivery of an advertisement to the client device 110. In some implementations, the server 130 may be used to receive the picture, the date and time the picture was taken, and the coordinates captured, for each picture taken, transmitted over a network from the client device 110

In some implementations, the server 130 may be used to receive data collected (e.g., pictures, date and time stamps, and coordinates) and transmitted over a network from a client device 110 to measure and create various reports regarding the performance of deliverers.

Client devices 110a and 110b (collectively “client devices 110”) are depicted as a mobile phone 110a and a desktop computer 110b, respectively, but client devices 110 may comprise any type of computing device, such as a desktop computer system, a laptop, cellular phone, a smart device, a mobile telephone, a tablet-style computer, or any other device capable of wireless or wired communication. In some implementations, client devices 110 are configured to interact with the server 130 via an application, such as a web browser or a native application, residing on the client device 110.

In some implementations, the client devices 110 include hardware, software, or embedded logic components or a combination of two or more such components and is configured to carry out the appropriate functions implemented or supported by the client devices 110.

In some implementations, the client devices 110 may include one or more processors, one or more memories, one or more displays, one or more interfaces, one or more components capable of inputting data, one or more components capable of outputting data, one or more components capable of communicating with any other component of the environment 100 or any other component suitable for a particular purpose.

In some implementations, the client devices 110 are configured to access networks 120 and/or 125. In some implementations, the client devices 110 are configured to communicate with servers 130.

In some implementations, the client devices 110 can connect to the network 125 through a wireless cellular network 120, such as GPRS-based and CDMA-based wireless networks, as well as 802.16 WiMax and long-range wireless data networks.

In some implementations, components of the environment 100 may communicate with any other component of the environment 100 over network 125. Network 125 may be any suitable network. In some implementations, for example, one or more portions of network 125 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another network 125, or a combination of two or more of the foregoing.

In some embodiments, components of the environment 100 may be configured to communicate over links 150. Links 150 may connect components of the environment 100 to networks 120, 125 or to each other. In some implementations, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links 150. Links 150 may not be the same throughout the environment 100.

In some implementations, the server devices 130 may include a processor, memory, user accounts, and one or more modules to perform various functions such as those described above.

In some implementations, each server 130 may be a unitary server or may be a distributed server spanning multiple computers or multiple datacenters. Servers 130 may be of various types, such as, for example and without limitation, web server, file server, application server, exchange server, database server, or proxy server. In some implementations, each server 130 may include hardware, software, or embedded logic components or a combination of two or more such components for carrying out the appropriate functionalities implemented or supported by server 130. For example, a web server is generally capable of hosting websites containing web pages or particular elements of web pages. More specifically, a web server may host HTML files or other file types, or may dynamically create or constitute files upon a request, and communicate them to clients 110 in response to HTTP or other requests from clients 110. A database server is generally capable of providing an interface for managing data stored in one or more data stores.

In some implementations, one or more data storages 130a may be communicatively linked to one or more servers 130, respectively, via one or more links 150. In some implementations, data storages 130a may be used to store various types of information. For example, in some implementations, the data storages 130a may be used to store data (such as addresses) that can be received and displayed by the client 110. In some implementations, the data storages 130a may be used to store data (such as pictures and related information described above) for processing by the server 130.

In some implementations, the data storages 130a may be used to store the picture, the date and time the picture was taken, and the coordinates captured for each picture taken using the client device 110 and transmitted over a network to the server 130 to create a live map. In some implementations, the data storages 130a may be used to store the addresses for advertisement campaigns that are transmitted over a network to a client device 110.

In some implementations, the data storages 130a may be used to store any other suitable data related to the use of the software for monitoring targeted front door media distribution campaigns by a client device 110 and/or server 130.

This disclosure contemplates computer system 200 taking any suitable physical form. In some implementations, as an example and not by way of limitation, computer system 200 may be an embedded computer system, a system-on-chip (SOC), a single-board computer system (SBC) (such as, for example, a computer-on-module (COM) or system-on-module (SOM)), a desktop computer system, a laptop, an interactive kiosk, a mainframe, a mesh of computer systems, a mobile telephone, a personal digital assistant (PDA), a server, or a combination of two or more of these.

In some implementations, where appropriate, computer system 200 may include one or more computer systems 200; be unitary or distributed; span multiple locations; span multiple machines; or reside in a cloud, which may include one or more cloud components in one or more networks.

In some implementations, where appropriate, one or more computer systems 200 may perform without substantial spatial or temporal limitation one or more steps of one or more methods described or illustrated herein. In some implementations, as an example and not by way of limitation, one or more computer systems 200 may perform in real time or in batch mode one or more steps of one or more methods described or illustrated herein. In some implementations, one or more computer systems 200 may perform at different times or at different locations one or more steps of one or more methods described or illustrated herein, where appropriate.

In some implementations, computer system 200 includes a processor 202, memory 204, storage 206, an input/output (I/O) interface 208, a communication interface 210, and a bus 212. Although this disclosure describes and illustrates a particular computer system having a particular number of particular components in a particular arrangement, this disclosure contemplates any suitable computer system having any suitable number of any suitable components in any suitable arrangement.

In some implementations, processor 202 includes hardware for executing instructions, such as those making up a computer program. In some implementations, as an example and not by way of limitation, to execute instructions, processor 202 may retrieve (or fetch) the instructions from an internal register, an internal cache, memory 204, or storage 206; decode and execute them; and then write one or more results to an internal register, an internal cache, memory 204, or storage 206.

In some implementations, processor 202 may include one or more internal caches for data, instructions, or addresses. The present disclosure contemplates processor 202 including any suitable number of any suitable internal caches, where appropriate. In some implementations, as an example and not by way of limitation, processor 202 may include one or more instruction caches, one or more data caches, and one or more translation look-aside buffers (TLBs).

In some implementations, instructions in the instruction caches may be copies of instructions in memory 204 or storage 206, and the instruction caches may speed up retrieval of those instructions by processor 202.

In some implementations, data in the data caches may be copies of data in memory 204 or storage 206 for instructions executing at processor 202 to operate on; the results of previous instructions executed at processor 202 for access by subsequent instructions executing at processor 202 or for writing to memory 204 or storage 206; or other suitable data.

In some implementations, the data caches may speed up read or write operations by processor 202. In some implementations, the TLBs may speed up virtual-address translation for processor 202.

In some implementations, processor 202 may include one or more internal registers for data, instructions, or addresses. The present disclosure contemplates processor 202 including any suitable number of any suitable internal registers, where appropriate. Where appropriate, processor 202 may include one or more arithmetic logic units (ALUs); be a multi-core processor; or include one or more processors 202. Although this disclosure describes and illustrates a particular processor, this disclosure contemplates any suitable processor.

In some implementations, memory 204 includes main memory for storing instructions for processor 202 to execute or data for processor 202 to operate on. In some implementations, as an example and not by way of limitation, computer system 200 may load instructions from storage 206 or another source (such as, for example, another computer system 200) to memory 204.

In some implementations, processor 202 may then load the instructions from memory 204 to an internal register or internal cache. In some implementations, to execute the instructions, processor 202 may retrieve the instructions from the internal register or internal cache and decode them.

In some implementations, during or after execution of the instructions, processor 202 may write one or more results (which may be intermediate or final results) to the internal register or internal cache. In some implementations, processor 202 may then write one or more of those results to memory 204.

In some implementations, processor 202 executes only instructions in one or more internal registers or internal caches or in memory 204 (as opposed to storage 206 or elsewhere) and operates only on data in one or more internal registers or internal caches or in memory 204 (as opposed to storage 206 or elsewhere).

In some implementations, one or more memory buses (which may each include an address bus and a data bus) may couple processor 202 to memory 204. In some implementations, bus 212 may include one or more memory buses, as described below.

In some implementations, one or more memory management units (MMUs) reside between processor 202 and memory 204 and facilitate accesses to memory 204 requested by processor 202.

In some implementations, memory 204 includes random access memory (RAM). In some implementations, this RAM may be volatile memory, where appropriate.

In some implementations, where appropriate, this RAM may be dynamic RAM (DRAM) or static RAM (SRAM). Moreover, in some implementations, where appropriate, this RAM may be single-ported or multi-ported RAM. The present disclosure contemplates any suitable RAM.

In some implementations, memory 204 may include one or more memories 204, where appropriate. Although this disclosure describes and illustrates particular memory, this disclosure contemplates any suitable memory.

In some implementations, storage 206 includes mass storage for data or instructions. In some implementations, as an example and not by way of limitation, storage 206 may include an HDD, a floppy disk drive, flash memory, an optical disc, a magneto-optical disc, magnetic tape, or a Universal Serial Bus (USB) drive or a combination of two or more of these.

In some implementations, storage 206 may include removable or non-removable (or fixed) media, where appropriate. In some implementations, storage 206 may be internal or external to computer system 200, where appropriate. In some implementations, storage 206 is non-volatile, solid-state memory.

In some implementations, storage 206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 206 taking any suitable physical form.

In some implementations, storage 206 may include one or more storage control units facilitating communication between processor 202 and storage 206, where appropriate. In some implementations, where appropriate, storage 206 may include one or more storages 206. Although this disclosure describes and illustrates particular storage, this disclosure contemplates any suitable storage.

In some implementations, I/O interface 208 includes hardware, software, or both providing one or more interfaces for communication between computer system 200 and one or more I/O devices. In some implementations, computer system 200 may include one or more of these I/O devices, where appropriate.

In some implementations, one or more of these I/O devices may enable communication between a person and computer system 200. In some implementations, as an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these.

In some implementations, an I/O device may include one or more sensors. This disclosure contemplates any suitable I/O devices and any suitable I/O interfaces 208 for them.

In some implementations, where appropriate, I/O interface 208 may include one or more device or software drivers enabling processor 202 to drive one or more of these I/O devices. I/O interface 208 may include one or more I/O interfaces 208, where appropriate. Although this disclosure describes and illustrates a particular I/O interface, this disclosure contemplates any suitable I/O interface.

In some implementations, communication interface 210 includes hardware, software, or both providing one or more interfaces for communication (such as, for example, packet-based communication) between computer system 200 and one or more other computer systems 200 or one or more networks.

In some implementations, as an example and not by way of limitation, communication interface 210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 210 for it.

In some implementations, as an example and not by way of limitation, computer system 200 may communicate with an ad hoc network, a personal area network (PAN), a local area network (LAN), a wide area network (WAN), a metropolitan area network (MAN), or one or more portions of the Internet or a combination of two or more of these.

In some implementations, one or more portions of one or more of these networks may be wired or wireless. In some implementations, as an example, computer system 200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these.

In some implementations, computer system 200 may include any suitable communication interface 210 for any of these networks, where appropriate. In some implementations, communication interface 210 may include one or more communication interfaces 210, where appropriate. Although this disclosure describes and illustrates a particular communication interface, this disclosure contemplates any suitable communication interface.

In some implementations, bus 212 includes hardware, software, or both coupling components of computer system 200 to each other. In some implementations, as an example and not by way of limitation, bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these.

In some implementations, bus 212 may include one or more buses 212, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. In some implementations, as an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate.

Herein, reference to a computer-readable storage medium excludes any medium that is not eligible for patent protection under 35 U.S.C. § 101. Herein, reference to a computer-readable storage medium excludes transitory forms of signal transmission (such as a propagating electrical or electromagnetic signal per se) to the extent that they are not eligible for patent protection under 35 U.S.C. § 101.

This disclosure contemplates one or more computer-readable storage media implementing any suitable storage. In some implementations, a computer-readable storage medium implements one or more portions of processor 202 (such as, for example, one or more internal registers or caches), one or more portions of memory 204, one or more portions of storage 206, or a combination of these, where appropriate.

In some implementations, a computer-readable storage medium implements RAM or ROM. In some implementations, a computer-readable storage medium implements volatile or persistent memory.

In some implementations, one or more computer-readable storage media embody software. Herein, reference to software may encompass one or more applications, bytecode, one or more computer programs, one or more executables, one or more instructions, logic, machine code, one or more scripts, or source code, and vice versa, where appropriate.

In some implementations, software includes one or more application programming interfaces (APIs). This disclosure contemplates any suitable software written or otherwise expressed in any suitable programming language or combination of programming languages.

In some implementations, software is expressed as source code or object code. In some implementations, software is expressed in a higher-level programming language, such as, for example, C, Perl, or a suitable extension thereof. In some implementations, software is expressed in a lower-level programming language, such as assembly language (or machine code).

In some implementations, software is expressed in JAVA. In some implementations, software is expressed in Hyper Text Markup Language (HTML), Extensible Markup Language (XML), or other suitable markup language.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example, it will be apparent to one of ordinary skill in the art that the invention may be used with any electronic network service, even if it is not provided through a website.

Any computer-based system that provides networking functionality can be used in accordance with the present invention even if it relies, for example, on email, instant messaging or other forms of peer-to-peer communications, and any other technique for communicating between users. The invention is thus not limited to any particular type of communication system, network, protocol, format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

While the foregoing processes and mechanisms can be implemented by a wide variety of physical systems and in a wide variety of network and computing environments, the server or computing systems described below provide example computing system architectures for didactic, rather than limiting, purposes.

The present invention has been explained with reference to specific embodiments. For example, while embodiments of the present invention have been described as operating in connection with a network system, the present invention can be used in connection with any communications facility that allows for communication of messages between users, such as an email hosting site. Other embodiments will be evident to those of ordinary skill in the art. It is therefore not intended that the present invention be limited, except as indicated by the appended claims.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

The present disclosure encompasses all changes, substitutions, variations, alterations, and modifications to the example embodiments herein that a person having ordinary skill in the art would comprehend.

The figures, including photographs and drawings, comprised herewith may represent one or more implementations of the software for monitoring targeted front door media distribution campaigns.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A computer-implemented method for monitoring targeted front door media distribution campaigns, the method comprising:
receiving and displaying at a first computing device a plurality of addresses for delivery of an advertisement wherein the plurality of addresses are transmitted over a network from a second computing device and wherein the addresses are not based on orders from the addressees;
for each address, capturing at the first computing device a picture of the advertisement at the address and capturing the date and time the picture was captured wherein the picture, date, and time are transmitted over a network to the second computing device; and
for each address, capturing at the first computing device the location of the first computing device wherein the location of the first computing device is transmitted over a network to the second computing device.

2. The computer-implemented method of claim 1 wherein displaying at the first computing device a plurality of addresses comprises displaying each address on a separate row based on a particular delivery sequence.

3. The computer-implemented method of claim 1 wherein capturing at the first computing device a picture of the advertisement at the address comprises for each address displaying at the first computing device a first user-selectable indicia for the deliverer to select to take a picture of the advertisement at the address, selecting the first user-selectable indicia at the first computing device by the deliverer, and taking a picture of the advertisement at the address at the first computing device by the deliverer.

4. The computer-implemented method of claim 1 wherein capturing the location of the first computing device comprises capturing the location of the first computing device automatically when the picture is captured using location information on the first computing device.

5. The computer-implemented method of claim 1 wherein capturing the location of the first computing device comprises for each address displaying at the first computing device a second user-selectable indicia for the deliverer to select to capture the location of the first computing device and selecting the second user-selectable indicia at the first computing device by the deliverer wherein location information on the first computing device is captured.

6. The computer-implemented method of claim 1 further comprising capturing at the first computing device a picture of a condition associated with an address and receiving an indication at the first computing device that the advertisement is undeliverable at the address wherein the picture and condition are transmitted over a network to the second computing device.

7. The computer-implemented method of claim 1 further comprising creating a clickable map based on the location information and pictures transmitted to the second computing device wherein the clickable map displays the picture associated with the location when the location is selected on the clickable map.

8. The computer-implemented method of claim 1 further comprising storing the received pictures in association with the addresses at the second computing device for future inquiry of the condition at the address.

9. The computer-implemented method of claim 6 further comprising creating a bad address list and good address list based on received information at the second computing system and using the list for future campaigns.

10. A computer-implemented method for monitoring targeted front door media distribution campaigns, the method comprising:
receiving and displaying at a first computing device a plurality of addresses for delivery of an advertisement wherein the plurality of addresses are transmitted over a network from a second computing device, wherein the addresses are not based on orders from the addressees, and wherein each address is displayed on a separate row based on a particular delivery sequence and on each row is displayed a first user-selectable indicia for the deliverer to select to take a picture of the advertisement at the address and a second user-selectable indicia for the deliverer to select to capture the location of the first computing device;
for at least some of the addresses, capturing at the first computing device a picture of the advertisement at the address by selecting the first user-selectable indicia at the first computing device by the deliverer and taking a picture of the advertisement at the address at the first computing device by the deliverer and capturing the date and time the picture was captured wherein the picture, date, and time are transmitted over a network to the second computing device;
for at least some of the addresses, capturing at the first computing device the location of the first computing device by selecting the second user-selectable indicia at the first computing device by the deliverer wherein the location of the first computing device is transmitted over a network to the second computing device;
for at least some of the addresses, capturing at the first computing device a picture of a condition associated with an address and receiving an indication at the first computing device that the advertisement is undeliverable at the address wherein the picture and condition are transmitted over a network to the second computing device;
creating a clickable map based on the location information and pictures transmitted to the second computing device wherein the clickable map displays the picture associated with the location when the location is selected on the clickable map; and
storing the received pictures in association with the addresses at the second computing device for future inquiry of the condition at the address.

11. A computer-implemented method for monitoring targeted front door media distribution campaigns, the method comprising:
not receiving and not displaying at a first computing device a plurality of addresses for delivery of an advertisement,
displaying a first user-selectable indicia for the deliverer to select to take a picture of the advertisement at an address wherein the address is not based on an order from the addressee,
displaying a second user-selectable indicia for the deliverer to select to capture the location of the first computing device;
for at least some of the addresses wherein the addresses are not based on orders from the addressees, capturing at the first computing device a picture of the advertisement at the address by selecting the first user-selectable indicia at the first computing device by the deliverer and taking a picture of the advertisement at the address at the first computing device by the deliverer and capturing the date and time the picture was captured wherein the picture, date, and time are transmitted over a network to the second computing device;
for at least some of the addresses wherein the addresses are not based on orders from the addressees, capturing at the first computing device the location of the first computing device by selecting the second user-selectable indicia at the first computing device by the deliverer wherein the location of the first computing device is transmitted over a network to the second computing device; and
for at least some of the addresses wherein the addresses are not based on orders from the addressees, capturing at the first computing device a picture of a condition associated with an address and receiving an indication at the first computing device that the advertisement is undeliverable at the address wherein the picture and condition are transmitted over a network to the second computing device.
